(19) United States
(12) Patent Application Publication
(10) Pub. No.: US 2026/0241912 A1
(43) Pub. Date: Aug. 20, 2026

(54) ELECTROMECHANICAL BRAKE

(71) Applicant: Robert Bosch GmbH, Stuttgart (DE)

(72) Inventors: Jochen Moench, Sinzheim (DE); Andrej Gardt, Abstatt (DE); Bernd Lutz, Kempten (DE); Dietmar Kratzer, Hersbruck (DE); Felix Zimmermann, Asperg (DE); Mark Boehm, Lehrensteinsfeld (DE); Mark Rennie, Ludwigsburg (DE); Martin Winkler, Sonthofen (DE); Nicolas Gieringer, Oppenau (DE); Paul Geubel, Baden-Baden (DE); Yakup Navruz, Heilbronn (DE)

(21) Appl. No.: 19/161,897

(22) PCT Filed: Apr. 29, 2024
(86) PCT No.: PCT/EP2024/061712

§ 371 Date: Sep. 3, 2025

(30) Foreign Application Priority Data
Jun. 6, 2023 (DE) 10 2023 205 255.5

(51) Int. Cl. B60T 13/74; B60T 1/06

(52) U.S. Cl. CPC B60T 13/746; B60T 1/065

(57) ABSTRACT

An electromechanical brake for braking a motor vehicle. The electromechanical brake includes an electric motor with a shaft via which a gear unit can be driven to adjust a brake actuator. The gear unit includes a worm/helical gear mechanism with a worm and a plastic helical gear, wherein the worm is disposed on the shaft of the electric motor, and wherein a worm axis and an axis of the plastic helical gear have different orientations relative one another.

### FIELD

The present invention relates to an electromechanical brake for braking a motor vehicle. The present invention also relates to a motor vehicle comprising such a brake.

### BACKGROUND INFORMATION

A service brake is usually a brake that uses brake fluid to press a brake piston together with a brake pad onto a brake disc in order to brake the vehicle. As the electrification of units in motor vehicles increases, the service brake, too, should be configured as an electromechanical brake so that the need for brake fluid and the associated complex valve and line structure can be eliminated. Such an electromechanical brake could also significantly reduce maintenance costs.

German Patent Application No. DE 10 2022 120 373 A1 describes an electromechanical brake with a drum brake. The electromechanical brake comprises an electric motor that drives a first gear. This first gear is operatively connected to a second gear, so that the second gear is driven via the first gear. A shaft, on which a worm is disposed, is configured on the second gear. The worm is in engagement with a worm gear and with it forms a worm gear mechanism. The worm gear drives a spindle drive unit of a brake actuator, via which two brake pads of the drum brake can be placed against the drum for braking.

An object of the present invention is to provide an electromechanical brake that can be disposed in a space-saving manner and is economical to manufacture.

The object may be achieved by an electromechanical brake having certain features of the present invention. Preferred example embodiments of the present invention can be found in the disclosure herein.

### SUMMARY

The present invention provides an electromechanical brake for braking a motor vehicle. The electromechanical brake comprises an electric motor with a shaft via which a gear unit can be driven to adjust a brake actuator. The gear unit comprises a worm/helical gear mechanism with a worm and a plastic helical gear, wherein the worm is disposed on a shaft of the electric motor, and wherein a worm axis and an axis of the plastic helical gear have different orientations relative one another.

A worm/helical gear mechanism is a gearing consisting of a worm and a helical gear that are oriented at different angles to it. This results in point contact between the worm and the helical gear. A worm gear mechanism, on the other hand, is a gearing in which there is linear flank contact. This means that the worm gear and the worm are at an angle of 90° to one another. A worm axis and an axis of the plastic helical gear, however, can have an angle other than 90°. The advantage of a worm/helical gear mechanism over a worm gear mechanism is that, because of the point contact, a worm/helical gear mechanism is less sensitive to tolerance deviations of the components or during installation. This makes it more economical to manufacture an electromechanical brake with a helical gear mechanism.

A worm/helical gear mechanism also has the advantage that the position of the electric motor is not fixed to 90. This enables more variable positioning of the electric motor, as a result of which special installation conditions can be taken into account. The electric motor can also be positioned on the housing in a more space-saving manner, so that such an electromechanical brake can be configured in a more installation space-saving manner.

According to an example embodiment of the present invention, the helical gear is configured as a plastic helical gear. The plastic helical gear can therefore be easily manufactured by means of an injection molding process. Compared to a helical gear made of metal, this makes it possible to ensure that the tolerances are permanently maintained so that the number of reject parts can be minimized and the manufacturing costs reduced. A plastic helical gear also saves weight and material costs. This makes it possible to reduce the unsprung mass on the wheel. It also improves the driving characteristics of the motor vehicle.

The plastic helical gear is advantageously made of a polyoxymethylene (POM), polyamide 6.6 (PA66), polyamide 4.6 (PA46) or polyetheretherketone (PEEK) plastic. Such plastics exhibit good tribological properties. These plastics exhibit favorable elasticity, so that contact with the worm causes the surface to flatten. This increases the contact surface and reduces surface tension during contact. This moreover also results in favorable tolerance sensitivity with respect to position tolerances of the wheel and the worm.

The plastic helical gear is particularly preferably made of an unreinforced plastic. In other words, the plastic does not contain any reinforcing fibers. Aside from the fact that unreinforced plastic is more economical than reinforced plastic, it also ensures that the surface can be flattened.

In an advantageous example embodiment of the present invention, the electromechanical brake is a service brake. The brake actuator is particularly preferably configured as a disc brake.

In another preferred example embodiment of the present invention, the helical gear mechanism has a transmission ratio between 6 and 50. Such a transmission ratio implemented in just one stage. Such a transmission ratio makes it possible to use a more cost-efficient, smaller and lighter electric motor. This then additionally reduces the installation space needed for the electromechanical brake. The lighter electric motor further reduces the mass disposed on the wheel, which improves the driving characteristics of the motor vehicle. The electric motor advantageously has a diameter of less than or equal to 65 mm and a length of less than 30 mm. The diameter is particularly preferably less than 50 mm.

The axis of the plastic helical gear and the worm axis preferably have an angle to one another between 60° and 120°. Such an angular range ensures that the friction between the plastic helical gear and the worm is kept low, so that the service life of such a transmission is not reduced as a result of wear.

In an advantageous further development of the present invention, the plastic helical gear is configured such that it is semi-globoid. In a semi-globoid configuration of the plastic helical gear, one shoulder of the gear is raised. This increases the contact surface with the worm in one direction of rotation, which reduces the surface load. Such a configuration increases the tooth stiffness, which in turn increases the load capacity of the plastic helical gear. Cost-efficient production by injection molding without expensive sliding elements is maintained.

A lead angle of the worm is advantageously greater than 6°. Such a lead angle prevents self-locking of the worm. This has the advantage that, if the electric motor fails while the brake is applied, the brake can be released again.

In one advantageous example embodiment of the present invention, the worm is configured as a multi-start worm. A multi-start worm comprises more than one worm tooth winding around the shaft. A multi-start worm is more efficient than a single-start worm. The tendency to self-lock is reduced as well.

In another advantageous example embodiment of the present invention, the plastic helical gear has straight toothing. In contrast to a plastic helical gear with angled toothing, a plastic helical gear with straight toothing can be manufactured more economically and with more precision. A straight-toothed injection-molded part is also easier to remove from the injection mold.

According to an example embodiment of the present invention, the helical gear is directly connected to a spindle gear, via which a brake piston can be moved axially. There are therefore no further gear components disposed between the helical gear and the spindle gear. This makes it possible to reduce the number of parts and the installation space needed for such an electromechanical brake. It also keeps the play in the gear unit, which increases with each gear element, low. This type of gear unit therefore has a better response time for quick braking maneuvers, such as ABS braking.

According to an example embodiment of the present invention, the shaft of the electric motor and the worm are advantageously configured as separate parts that can be connected to one another. Even though the shaft and the worm can also be formed together as one part, they are configured separately. This allows the worm gear to be manufactured more independently, which simplifies production. If a manufactured worm fails to meet the tolerance dimensions, only the worm needs to be discarded. Such a separate configuration of the parts makes the manufacturing of these parts more economical and easier.

According to an example embodiment of the present invention, the shaft of the electric motor and the worm are preferably formed together in one piece. This eliminates the need for couplings and bearings on the two shafts. Compared to mounting the worm gear on the motor shaft, the diameter of the worm can be kept small. This increases the efficiency of the worm/helical gear mechanism, which is advantageous in terms of the motor power to be installed and thus reduces the cost and the installation space needed by the motor and the power required for braking.

The present invention also provides a motor vehicle that comprises the electromechanical brake according to the present invention. Such a motor vehicle has the above-described advantages.

Embodiment examples of the present invention are shown in the figures and explained in more detail in the following description.

### BRIEF DESCRIPTION OF THE DRAWINGS

FIG. 1 shows a perspective view of an electromechanical brake according to an embodiment example of the present invention.

FIG. 2 shows a sectional view of the electromechanical brake, according to an example embodiment of the present invention.

### DETAILED DESCRIPTION OF EXAMPLE EMBODIMENTS

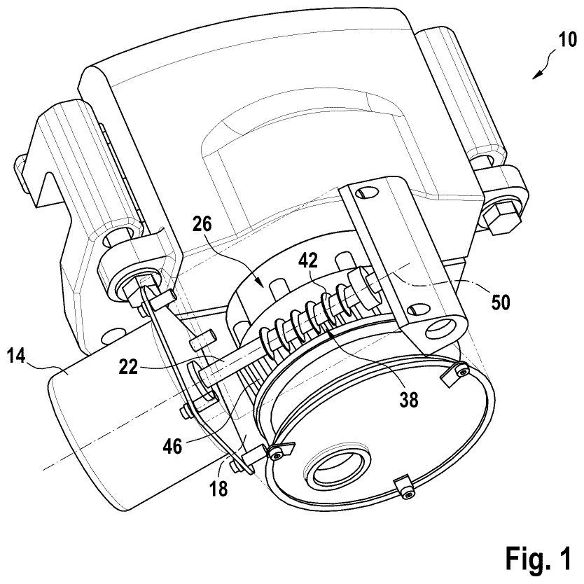

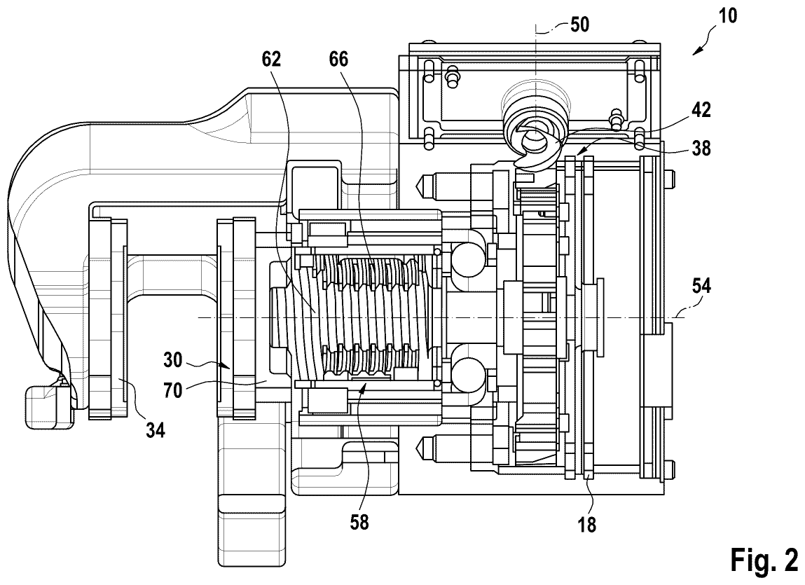

FIG. 1 shows a perspective view of an electromechanical brake 10 according to an embodiment example of the present invention. The electromechanical brake 10 comprises an electric motor 14, which is mounted to a housing 18 of the electromechanical brake 10. The electric motor 14 comprises a shaft 22 which projects into the housing 18. A gear unit 26 is driven via the shaft 22. A brake actuator 30, which in this embodiment example is configured as a disc brake (see FIG. 2), can be moved via the gear unit 26. Adjusting the brake pads 34 of the disc brake 30 enables them to be placed against a here-not-depicted brake disc, so that the motor vehicle is braked.

The gear unit 26 comprises a worm/helical gear mechanism 38. A worm 42 of the worm/helical gear mechanism 38 is configured on the shaft 22 of the electric motor 14. The worm 42 is in engagement with a plastic helical gear 46. In the shown embodiment example, a worm axis 50 is disposed almost orthogonally to an axis 54 of the plastic helical gear 46. The plastic helical gear 46 is configured such that it is straight-toothed without a semi-globoid shape.

FIG. 2 shows a sectional view of the electromechanical brake 10. This figure shows that the gear unit 26 also comprises a spindle gear 58. In this embodiment example, the spindle gear 58 is configured as a ball spindle gear. The spindle gear 58 comprises a spindle 62 that is directly connected to the plastic helical gear 46. There are therefore no further gear components disposed between the plastic helical gear 46 and the spindle gear 58, so the gear unit 26 can be compact. The spindle 62 is operatively connected to a spindle nut 66 so that a rotational rotation of the spindle 62 leads to a translational movement of the spindle nut 66. A brake piston 70 is moved axially via the spindle nut 66, which applies a force to the brake pad 34.

1-12. (canceled)

13. An electromechanical brake for braking a motor vehicle, comprising:
an electric motor with a shaft via which a gear unit can be driven to adjust a brake actuator;
wherein the gear unit includes a worm/helical gear mechanism with a worm and a plastic helical gear, wherein the worm is disposed on the shaft of the electric motor, and wherein a worm axis and an axis of the plastic helical gear have different orientations relative one another.

14. The electromechanical brake according to claim 13, wherein the brake actuator is a disc brake.

15. The electromechanical brake according to claim 13, wherein the worm/helical gear mechanism has a transmission ratio between 6 and 50.

16. The electromechanical brake according to claim 13, wherein the axis of the plastic helical gear and the worm axis have an angle to one another between 60° and 120°.

17. The electromechanical brake according to claim 13, wherein the plastic helical gear is configured such that it is semi-globoid.

18. The electromechanical brake according to claim 13, wherein a lead angle of the worm is greater than 6°.

19. The electromechanical brake according to claim 13, wherein the plastic helical gear has straight toothing.

20. The electromechanical brake according to claim 13, wherein the plastic helical gear is directly connected to a spindle gear, via which a brake piston can be moved axially.

21. The electromechanical brake according to claim 13, wherein the electric motor has a diameter of less than or equal to 65 mm and a length of less than 30 mm.

22. The electromechanical brake according to claim 13, wherein the shaft of the electric motor and the worm are formed together in one piece.

23. The electromechanical brake according to claim 13, wherein the shaft of the electric motor and the worm are configured as separate parts that can be connected to one another.

24. A motor vehicle, comprising:
an electromechanical brake for braking the motor vehicle, the electromechanical brake including:
an electric motor with a shaft via which a gear unit can be driven to adjust a brake actuator,
wherein the gear unit includes a worm/helical gear mechanism with a worm and a plastic helical gear, wherein the worm is disposed on the shaft of the electric motor, and wherein a worm axis and an axis of the plastic helical gear have different orientations relative one another.
